(19) United States
(12) Patent Application Publication
(10) Pub. No.: US 2007/0183081 A1
(43) Pub. Date: Aug. 9, 2007

(54) Data storage device and defective area management method therefor

(75) Inventors: Junzou Noda, Kanagawa (JP); Shingo Hattori, Kanagawa (JP); Toshiaki Satoh, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B. V., Amsterdam (NL)

(21) Appl. No.: 11/650,332

(22) Filed: Jan. 5, 2007

(30) Foreign Application Priority Data
Jan. 6, 2006 (JP) 2006-001205

(51) Int. Cl. G11B 5/596

(52) U.S. Cl. 360/77.08; 360/75; 360/53

(57) ABSTRACT

Embodiments in accordance with the present invention increase the possibility that a servo track in which servo data is defective may be detected, greatly decreasing the possibility that a write error may occur during use by a user. According to one embodiment of the present invention, a defective area management method for a data storage device is provided. The data storage device comprises a head in which positions of read and write elements differ from each other in the radial direction of a disk. A defective area management method performs positioning of the head by reading out servo data written on the disk using the read element. The defective area management method comprises the steps of performing data write processing by use of the write element with the read element being positioned at a target position at which normal data reading is performed; and registering areas, as an error area, in a data track in which normal data writing is performed using a servo track including the target position if a predetermined error occurs in the data write processing.

### CROSS-REFERENCE TO RELATED APPLICATION

The instant nonprovisional patent application claims priority to Japanese Patent Application 2006-001205, filed Jan. 6, 2006 and is incorporated by reference herein for all purposes.

### BACKGROUND OF THE INVENTION

Embodiments in accordance with the present invention relate to a data storage device and a defective area management method therefor, and more particularly to defective area management of a data storage device including a head in which read/write offset exists.

Data storage devices using various types of media such as optical disks and magnetic tapes are known in the art. Among them, hard disk drives (HDDs) have proliferated as storage devices for computers to such an extent that they are one of the storage devices essential for today's computers. Further, the use of HDDs is not limited to computer systems and has greatly expanded because of its excellent characteristics. For example, HDDs are used for moving picture recording/reproducing devices, car navigation systems, and removable memories for use in digital cameras, and the like.

HDDs, which write and read data using a head element, adopt a sector servo system that performs positioning control of the head on the basis of servo data including a plurality of burst signals written in a servo area in a servo sector formed on a disk. A magnetic disk drive includes a magnetic disk. Each track of the magnetic disk is formed by servo data that is written on the magnetic disk by a servo writer, or the like.

Specifically, servo data is written so as to follow a concentric track. Servo data is written at a plurality of locations on a track. Each servo data includes address information of a servo track, and a burst pattern used for fine position control. There are four kinds of burst patterns, which are bursts A, B, C, and D. The burst pattern is read by the head. From the read signal (burst signal), a change in amplitude or the like can be obtained. Then, the change is digitized. The digitized change may be used, for example, for tracking control (track following) of the head. An HDD uses the burst pattern, which was read out by the head element, to calculate a position error signal (PES). The HDD performs positioning of the head element so that the servo track address and the calculated PES are close to target values thereof.

The positioning of the head performed by the sector servo system as described above is prevented by various factors including vibrations added to the HDD, disturbance caused by a shock, vibrational components of a motor, misalignment caused by deformation of a medium, and electric noises. In addition, if a servo control frequency band is increased to lessen the influence of disturbance such as vibrations from the outside, there is a possibility that a mechanical system of the HDD may oscillate. For this reason, a notch filter (band pass filter) and a low pass filter are placed to attenuate a mechanical resonance frequency.

Moreover, if data is written in a state in which the head element is misaligned, there is a possibility that the written data cannot be read out or the data is overwritten on an adjacent track which results in erasure of data in the adjacent track. Therefore, if the head is misaligned beyond a predetermined allowable value, it is designed not to write data. If write processing cannot be successfully executed because the head is misaligned beyond the allowable value, it is designated as a write error.

In recent years, the recording densities of HDDs have increased, and accordingly, intervals between each data track and each servo track and intervals between data sectors have become narrower. Therefore, an allowable value for fluctuations in position of a head element has decreased. Although intervals between servo tracks are determined by a servo writer, variations in intervals between servo tracks are generated due to variations in height of disks and heads, and variations in position of a head during servo write. Since intervals between tracks or intervals between sectors are becoming narrower, the variations in intervals between servo tracks can become larger.

For example, if the intervals between servo tracks vary, there is a possibility that a partially narrowed servo track may be formed. If a servo track is partially narrowed, writing data is performed on a position closer to a track adjacent to a desired track, instead of on the desired track. As a result, there is a possibility that a malfunction could occur, causing data on the adjacent track to be erased. This malfunction is called “squeeze”.

Squeeze is a phenomenon in which although the distance between the write element and read element is constant, data cannot be successfully read on a servo track, or a phenomenon in which data is overwritten on a track adjacent to a desired track, which is caused by, for example, a partially narrowed servo track. In this case, data in the track adjacent to the desired track is erased.

For this reason, a test, which is called SRST (Self Run Self Test), is performed for the HDD. A SAT (Surface Analysis Test) is performed for detecting an error area having a scratch, or the like, and detecting an error area in which a write error frequently occurs due to a defect of a servo track such as a narrow servo track and a servo track that cannot be read. These error areas are registered in a map called the PDM (Primary Defect Map), so as to disallow the use of these error areas.

In the process of the SRST, the above detection of an error area in which a write error frequently occurs is performed through processing called Filldata. During Filldata, data is written in the whole data area on a magnetic disk. If a write error occurs in a data track, all sectors included in the data track are registered in the PDM as error areas.

As far as the Filldata in the conventional data storage device is concerned, a head element (read element) is positioned at a read position that indicates positions of the read element and the write element upon normally reading data from each data track. Data is written by the write element. At this time, if a write error occurs in a certain data track, a data track at which the read element is located is determined as a defective track. Then, all sectors included in this track are registered in the PDM (refer to FIG. 9(a)).

Next, the head element (read element) is positioned at a write position that indicates a position at which data is normally written on each data track, and then data is written by the write element. At this time, if a write error occurs in a certain data track, a data track at which the write element is located (writing) is determined as a defective track. Then, all sectors included in this track are registered in the PDM (refer to FIG. 9(b)).

Japanese Patent Application Laid-Open No. 2004-171755

However, even if this SRST is performed, a malfunction including the squeeze phenomenon can still occur during use by a user. For example, if there is an area in which a servo track is partially narrowed when data write processing is performed, data can be written at a desired track during the SRST. If a user repeatedly uses the data storage device, a squeeze phenomenon occurs.

This problem can be solved by such inspection in which write processing is performed with the read element to be located at all parts of each track. However, it is necessary to spend an enormous amount of time to perform Filldata that covers everywhere in each servo track, which causes a new problem.

### BRIEF SUMMARY OF THE INVENTION

Embodiments in accordance with the present invention greatly increase the possibility that a servo track in which servo data is defective may be detected, greatly decreasing the possibility that a write error may occur during use by a user. According to one embodiment of the present invention, a defective area management method for a data storage device is provided. The data storage device comprises a head in which positions of read and write elements differ from each other in the radial direction of a disk. A defective area management method performs positioning of the head by reading out servo data written on the disk using the read element. The defective area management method comprises the steps of performing data write processing by use of the write element with the read element being positioned at a target position at which normal data reading is performed; and registering areas, as an error area, in a data track in which normal data writing is performed using a servo track including the target position if a predetermined error occurs in the data write processing.

### BRIEF DESCRIPTION OF THE DRAWINGS

FIG. 1 is a block diagram schematically illustrating a configuration of an HDD according to one embodiment of the present invention.

FIG. 2 is a schematic diagram illustrating write data areas on the recording surface of a magnetic disk.

FIGS. 3(a), 3(b) are schematic diagrams each illustrating servo data written in a servo area of a magnetic disk.

FIG. 4 is a diagram illustrating the positional relationship between each servo track and each data track in an HDD according to one embodiment of the present invention.

FIG. 5 is a conceptual diagram illustrating PDM registration of a data track at which a read element is located when a write error occurs during write processing at a read position when Filldata is performed.

FIG. 6 is an enlarged view illustrating the servo track shown in FIG. 5.

FIG. 7 is a conceptual diagram illustrating PDM registration of a data track at which a write element is located when a write error occurs during write processing at a read position (RP) when Filldata is performed.

FIG. 8 is a conceptual diagram illustrating PDM registration of each data track in which data write processing is performed by use of each servo track adjacent to a defective servo track.

FIGS. 9(a), 9(b) are conceptual diagrams each illustrating the conventional PDM registration of a defective servo track.

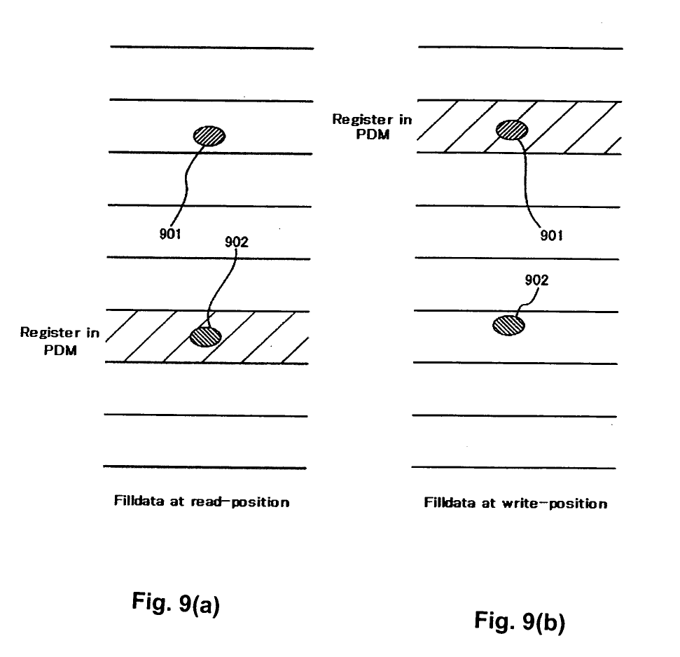

### DETAILED DESCRIPTION OF THE INVENTION

Embodiments in accordance with the present invention provide a defective area detection method that is performed in a shorter period of time than the time taken by Filldata, and covers all parts of each servo track. Embodiments of methods in accordance with the present invention seldom fail to detect a defective servo area.

According to one aspect of the present invention, a defective area management method for a data storage device is provided. The data storage device comprises a head in which positions of read and write elements differ from each other in the radial direction of a disk. In the defective area management method, positioning of the head is performed by reading out servo data written on the disk using the read element. The defective area management method comprises the steps of: performing data write processing using the write element with the read element being positioned at a target position at which normal data reading is performed; and registering areas in a data track in which normal data writing is performed using a servo track including the target position if a predetermined error occurs in the data write processing.

In addition to the areas in the data track in which normal data writing is performed using the servo track including the target position, error registration of areas in a data track adjacent to the data track may also be performed. In this case, it is desirable that an adjacent data track be selected as an adjacent data track by the write element during data write processing. In another case, in addition to the areas in the data track in which normal data writing is performed using the servo track including the target position, error registration of areas in each of adjacent data tracks on both sides of the data track may also be performed. This makes it possible to register all data tracks corresponding to the defective servo track in a PDM. Accordingly, it is possible to decrease the possibility of a malfunction of write processing which occurs during use by a user.

In addition, it is desirable to perform error registration of all data areas in each data track in which normal data writing is performed; or, it is desirable to perform error registration of areas in each data track corresponding to the target position. This makes it possible to register data tracks corresponding to the defective servo track in the PDM. Accordingly, it is possible to decrease the possibility of a malfunction of write processing which occurs during use by a user.

Moreover, in addition to the areas in the data track in which normal data writing is performed using the servo track including the target position, error registration of areas in a data track in which normal data writing is performed using a servo track adjacent to the servo track may also be performed. In this case, it is desirable that an adjacent servo track which is closer to the target position be selected as the adjacent servo track. Furthermore, in addition to the areas in the data track in which normal data writing is performed using the servo track including the target position, error registration of areas in each data track in which normal data writing is performed using each of adjacent servo tracks on both sides of the servo track may also be performed. As a result of the above processing, servo tracks adjacent to the defective servo track are also registered in the PDM as defective servo tracks. Therefore, it becomes possible to cope with an extensive defect.

According to another aspect of the present invention, a data storage device comprising:

a head in which positions of read and write elements differ from each other in the radial direction of a disk;

a controller for performing positioning control of the head on the basis of servo data read out from the disk by the read element, and thereby for performing data write processing by the write element with the read element being positioned at a target position at which normal data reading is performed; and

a memory for storing as an error area an area in a data track in which normal data writing is performed using a servo track including the target position if a predetermined error occurs during the data write processing.

This data storage device is capable of registering all data tracks corresponding to the defective servo track in a PDM. Accordingly, it is possible to decrease the possibility of a malfunction of write processing which occurs during use by a user.

In addition, the memory may also store, as an error area, not only the areas in the data track in which normal data writing is performed using the servo track including the target position, but also areas in a data track adjacent to the data track. In this case, it is desirable that an adjacent data track which is closer to the write element used for the data write processing be selected as the adjacent data track. In anther case, the memory may also store, as an error area, not only the areas in the data track in which normal data writing is performed using the servo track including the target position, but also areas in each of adjacent data tracks on both sides of the data track. Such a data storage device is capable of registering data tracks corresponding to the defective servo track in the PDM. Accordingly, it is possible to decrease the possibility of a malfunction of write processing which occurs during use by a user.

Moreover, the memory may also store, as an error area, not only the areas in the data track in which normal data writing is performed using the servo track including the target position, but also areas in a data track in which normal data writing is performed using a servo track adjacent to the servo track. In this case, it is desirable that an adjacent servo track which is closer to the target position be selected as the adjacent servo track. Furthermore, the memory may also store, as an error area, not only the areas in the data track in which normal data writing is performed using the servo track including the target position, but also areas in each data track in which normal data writing is performed using each of adjacent servo tracks on both sides of the servo track. In such a magnetic disk drive, servo tracks adjacent to the defective servo track are also registered in the PDM as defective servo tracks. Therefore, it becomes possible to cope with an extensive defect.

According to still another aspect of the present invention, a data storage device comprising:

a head in which positions of read and write elements differ from each other in the radial direction of a disk;

a controller for performing positioning control of the head on the basis of servo data read out from the disk by the read element, and thereby for performing data write processing by the write element with the read element being positioned at a target position at which normal data writing is performed; and

a memory for storing, as an error area, areas in a data track in which normal data reading is performed using a servo track including the target position if a predetermined error occurs in the data write processing.

Such a data storage device is capable of registering data tracks corresponding to the defective servo track in the PDM. Accordingly, it is possible to decrease the possibility of a malfunction of write processing which occurs during use by a user.

In addition, the memory may also store, as an error area, not only the areas in the data track in which normal data writing is performed using the servo track including the target position, but also areas in a data track adjacent to the data track. Moreover, the memory may also store, as an error area, not only the areas included in the data track in which normal data writing is performed using the servo track including the target position, but also areas in a data track in which normal data writing is performed using a servo track adjacent to the servo track. Such a data storage device is capable of registering data tracks corresponding to the defective servo track in the PDM. Accordingly, it is possible to decrease the possibility of a malfunction of write processing which occurs during use by a user.

In the defective area management method according an embodiment of the present invention, it is possible to detect an area in which a defect occurs in servo data, and an area in which a servo track is partially narrowed, both of which could not be found out by the conventional methods. As a result, it is possible to greatly reduce the number of times a malfunction occurs in a data storage device.

Embodiments of the present invention will be described as below. To clarify the description, the following description and drawings are omitted or simplified if appropriate. Also note that identical reference numerals are used for identical elements, and that redundant description is omitted as appropriate to clarify the description.

According to one embodiment of the present invention, the data storage device comprises a head in which positions of read and write elements differ from each other in the radial direction of a disk. The data storage device performs positioning of the head by reading out servo data written on the disk using the read element. When data write processing is performed by the write element with the read element being positioned at a target position at which normal data reading is performed, if a predetermined error occurs during this data write processing, error registration of areas in a data track in which normal data writing is performed is performed using a servo track including the target position.

The above processing makes it possible to increase the possibility of detecting a servo track having such a defect that an error does not occur when Filldata is performed whereas an error occurs during use by a user. As examples of such servo tracks, there are, for example, a servo track in which a defect locally occurs, and a partially narrowed servo track.

The above-mentioned error is a write error. The write error occurs if the head vibrates, instead of being stable, beyond the allowable value of the head misalignment for each data storage device since the positioning control is prevented by various factors including vibrations added to a data storage device, disturbance caused by a shock, a vibrational component of a motor, misalignment caused by deformation of a medium, and electric noises. In addition, the write error occurs if a servo track is partially narrowed, or if servo data is defective.

When a servo track is defective, it is not possible to read out servo data from this defective servo track. Thus, the read processing is repeatedly retried, and the vibration of the head element becomes larger. This causes a write error. Moreover, if a servo track is partially narrowed, servo data cannot be read out from some areas of this track although it can be read out from some other areas. In the case where the servo data cannot be read, the write error occurs.

If the write error occurs in a track, a write retry starts from a sector from which writing to the track has started. Then, the write retry is repeated until writing for one circumference of the disk is completed without an error. In addition, there are, for example, four conditions in which the write error occurs in a data storage device according to one embodiment of the present invention:

(1) Even if the write retry is repeated 15 times, the write retry cannot be successfully performed without an error;

(2) Although the write retry succeeds before the write retry is repeated 15 times, there are four or more sectors in which the write error occurs before the write retry succeeds, within a three servo sector area. Here, the three servo sector area is an area ranging from a certain servo sector to the second adjacent servo sector.

(3) Although the write retry succeeds before the write retry is repeated 15 times, there are many sectors in which read processing of servo data causes an error, which is a read error; and

(4) It is not possible to seek the track.

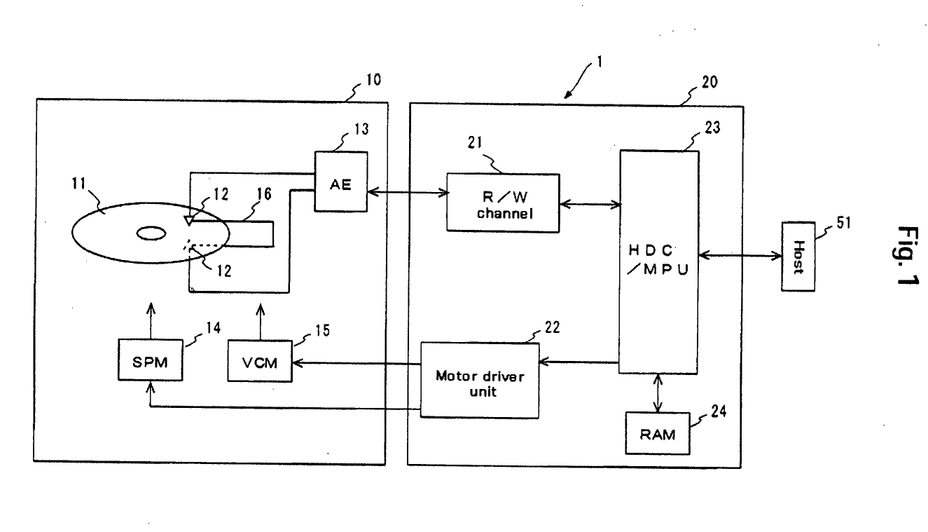

One example of data storage devices are hard disk drives. Taking a hard disk drive (HDD) as an example, an embodiment of the present invention will be described below. To easily understand the characteristics of this embodiment, the entire configuration of the HDD will be schematically described. FIG. 1 is a block diagram schematically illustrating a configuration of an HDD 1 according to this embodiment. As shown in FIG. 1, the HDD 1 includes a sealed enclosure 10, which houses: a magnetic disk 11 that is an example of a medium (recording medium); a head element 12 that is an example of a head; arm electronics (AE) 13; a spindle motor (SPM) 14; a voice coil motor (VCM) 15; and an actuator 16.

The HDD 1 further includes a circuit board 20 that is secured outside the enclosure 10. ICs are provided on the circuit board 20 including: a read/write channel (R/W channel) 21; a motor driver unit 22; an integrated circuit 23 including a hard disk controller (HDC) and an MPU (hereinafter referred to as “HDC/MPU”); and a RAM 24. Incidentally, the abovementioned circuits can be integrated into one IC; or can be implemented by dividing the circuit into a plurality of ICs.

User data from an external host 51 is received by the HDC/MPU 23. This user data is sent through the R/W channel 21 and the AE 13, and is then written on the magnetic disk 11 by the head element 12. On the other hand, the user data stored on the magnetic disk 11 is read out by the head element 12. The user data is sent through the AE 13 and the R/W channel 21, and is then output from the HDC/MPU 23 to the external host 51.

Next, each element of the HDD 1 will be described. The magnetic disk 11 is secured to the SPM 14. The SPM 14 rotates the magnetic disk 11 at predetermined speed. The motor driver unit 22 drives the SPM 14 according to control data sent from the HDC/MPU 23. The magnetic disk 11 according to an embodiment of the present invention has recording surfaces on both sides. Data is written on each of the recording surfaces. Head elements 12 are provided for each corresponding recording surface.

Each head element 12 is secured to a slider (not illustrated in the figure). The slider is secured to the tip of the actuator 16. The actuator 16 is connected to the VCM 15. The actuator 16 pivotally moves on the basis of a pivot shaft, which causes the head element 12 (and the slider) to move in the radial direction on the rotating magnetic disk 11. The motor driver unit 22 drives the VCM 15 according to control data (it is called DACOUT) that is received from the HDC/MPU 23.

The head element 12 includes: a write element for converting an electric signal into a magnetic field according to data written on the magnetic disk 11; and a read element for converting a magnetic field received from the magnetic disk 11 into an electric signal. When the head element 12 is located on the magnetic disk 11, positions of the write element and the read element differ from each other in the radial direction. This difference in position in the radial direction between the write element and the read element is called a read-write offset. It is to be noted that the required number of the magnetic disks 11 is one or more, and that a recording surface can be formed on one side, or both sides, of the magnetic disk 11.

The AE 13 selects from among the plurality of head elements 12, one head element 12 that is used to access the magnetic disk 11, and amplifies (preamplifies) at constant gain, a read signal read out by the selected head element 12. The AE 13 then transmits the amplified signal to the R/W channel 21. In addition, the AE 13 sends a write signal, which is received from the R/W channel 21, to the selected head element 112.

In the read processing, the R/W channel 21 amplifies a read signal supplied from the AE 13 so that the amplitude is kept constant, and then extracts data from the obtained read signal to perform decode processing. Data which is read out includes user data and servo data. The decoded read user data is supplied to the HDC/MPU 23. In addition, the R/W channel 21 executes the write processing according to a control signal received from the HDC/MPU 23. In the write processing, the R/W channel 21 performs code modulation of write data supplied from the HDC/MPU 23, and then converts the code-modulated write data into a write signal to supply the write signal to the AE 13.

In the HDC/MPU 23, the MPU operates according to codes loaded into the RAM 24. When the HDD 1 is started up, not only codes to operate on the MPU but also data required for control and data processing are loaded into the RAM 24 from the magnetic disk 11 or a ROM (not illustrated in the figure). The HDC/MPU 23 executes processing required for data processing such as read/write processing control, management of command execution order, positioning control (servo control) of the head elements 12 by use of a servo signal, interface control, and defect control, and also executes the total control of the HDD 1.

In defective-track detection processing, verification is performed whether or not the track width determined by a burst pattern is partially wide, and whether or not the track width is partially narrow. The burst pattern is included in servo data written on the magnetic disk 11. Then, each track (defective track) of which the width is not correct is registered in a defect table that is written in a predetermined area on the magnetic disk 11. In the manufacturing process, after the burst pattern is written, the device itself executes the defective-track detection processing as a verification process using the burst pattern. When data is written, the HDD 1 refers to the defect table, and thereby controls the writing so that the data is not written on the defective track that has been registered in the defect table.

When this defective-track detection processing is executed, a flag for starting test processing is set on the magnetic disk 11. When the power is turned on, a test processing program is read out from the magnetic disk 11, and is then loaded into the RAM 125 through the AE 13, the R/W channel 21, and the HDC/MPU 23. After that, the test processing program is executed. This test processing will be detailed later.

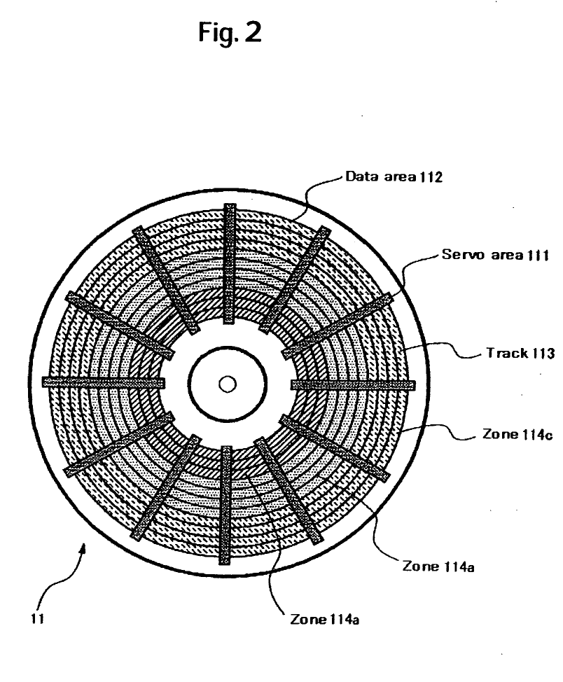

Next, write data on the magnetic disk 11 will be described with reference to FIG. 2. FIG. 2 is a diagram schematically illustrating a state of write data on a recording surface of the magnetic disk 11. As shown in FIG. 2, on the recording surface of the magnetic disk 11, a plurality of servo areas 111 are separately formed at intervals of a predetermined angle. Each of the servo areas 111 extends in a radial pattern in the radial direction from the center of the magnetic disk 11. Also, a plurality of data areas 1 12 are provided, each of which is formed between two adjacent servo areas 111. Thus, the servo areas 111 and the data areas 112 are alternately formed at intervals of the predetermined angle. Servo data used for the positioning control of the head element 112 is written in each servo area 111. User data is written in each of the data areas 112.

A plurality of tracks 113, each of which has the predetermined width in the radial direction, are concentrically formed on the recording surface of the magnetic disk 11. The servo data and the user data are written based on each of the tracks 113. One track 113 between the servo areas 111 includes a plurality of data sectors (the unit of writing user data). In other words, each track 113 includes the servo data that is written at a plurality of locations at intervals of the predetermined angle; and a plurality of data sectors, each of which is formed between the locations in which the servo data is written. The plurality of tracks 113 are grouped into a plurality of zones 114 according to the positions in the radial direction of the magnetic disk 11. The number of data sectors included in each track 113 is set in each zone. FIG. 2 illustrates three zones 114a through 114c.

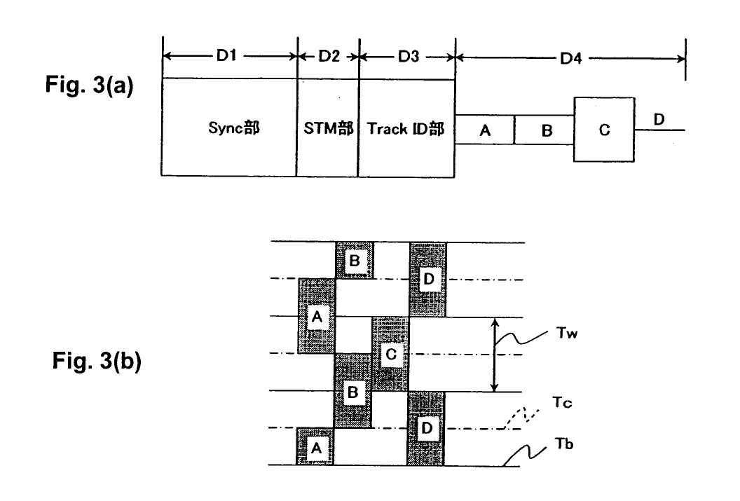

Next, servo data which is written in a servo area of the magnetic disk 11 will be described. Servo data used to follow a concentric track is written on the magnetic disk 11 that is a recording medium for a magnetic head used for writing data. The servo data is written to a plurality of points on a track. As shown in FIG. 3(a), the servo data is written in a plurality of areas including: a synchronization part D1 in which synchronization data used for data synchronization is written; an STM (Servo track mark) part D2 in which a servo mark indicating the start point of the servo data is written; a track ID part D3 having position information indicating the number of a track; and a burst part D4 in which burst patterns used for fine position control are written. Those areas are well-known.

For example, as shown in FIG. 3(b), there are four types of the burst patterns which are written in the burst part D4. Those are bursts A, B, C, and D. The burst patterns are read out by the read element. Then, the position in a servo track can be determined by the amplitude of each read signal (burst signal). Here, the position in the servo track is expressed with a PES value that indicates 256 parts divided by the servo track in the radial direction.

The target position of the head is determined by reading out the servo track using the read element. As a result, positioning of the head to a target position is performed. In this case, the positioning is performed by determining a PES value and the number of cylinders.

Referring to FIG. 3(b), the center of a track is denoted by Tc, the boundary of a track is denoted by Th, and the width of a track is denoted by Tw. The burst A is a signal written on one of track boundaries Th of a certain track. The burst B is a signal written on the other track boundary Th of the track. In addition, the burst C and the burst D are signals that are written within a track with an odd number or an even number, respectively.

The HDD 1 uses the burst patterns, which have been read out using the head element, to calculate a position error signal (PES). Both during read and write processing, the HDD 1 performs positioning of the read element using a servo track address read out using the read element and a calculated PES value as target values.

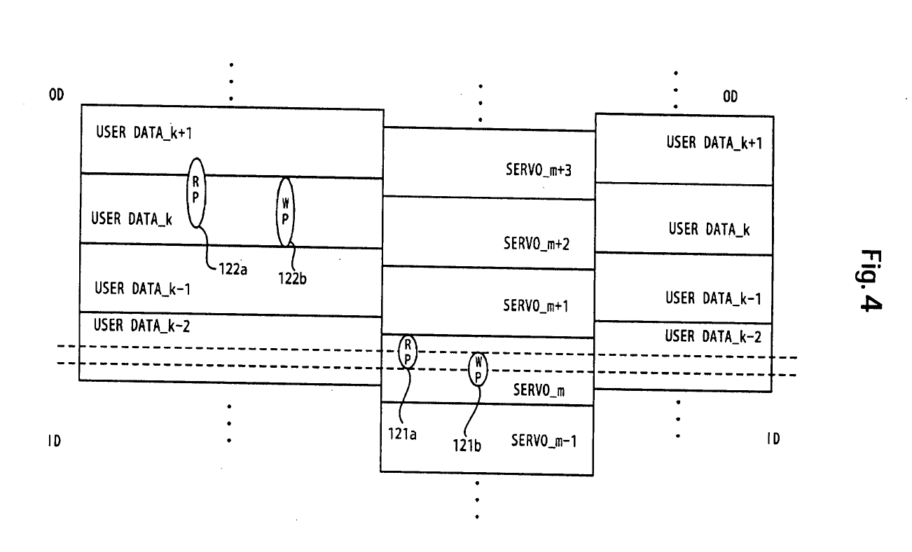

FIG. 4 is a diagram illustrating the positional relationship between each servo track and each data track in the HDD 1 according to one embodiment of the-present invention. In addition, FIG. 4 illustrates positions of the read element and the write element (read position: RP) during read processing on a data track, and positions of the read element and the write element (write position: WP) during write processing on a data track. Here, ID denotes the innermost track in the radial direction of the magnetic disk 11 while OD denotes the outermost track in the radial direction of the magnetic disk 11.

As shown in FIG. 4, when read processing on a data track USER DATA_k−2 is performed, data of the data track USER DATA_k−2 is read out by positioning the read element at the position of a read element 121a. In this case, the write element is at the position of a write element 122a.

On the other hand, when write processing on a data track USER DATA_k is performed, the write element is positioned at the position of a write element 122b since the read element is positioned at the position of a read element 121b. By positioning the write element at the position of the write element 122b, the write processing on the data track USER DATA_k is performed. In FIG. 4, both during the read processing of the data track USER DATA_k−2 and during the write processing of the data track USER DATA_k, servo track SERVO_m is used.

Through processing called Filldata, the HDD 1 according to this embodiment detects error areas in which a predetermined error (write error) frequently occurs during writing data. During Filldata, data is written in the whole data areas on a magnetic disk. If the write error occurs on a data track, all sectors in the data track are registered in a PDM as an error area.

To be more specific, taking FIG. 4 as an example, when write processing on the data track USER DATA_k by Filldata is performed, the write processing is performed at a position (WP) of the write element 122a and at a position (RP) of the write element 122b. The position (WP) is a position at which read processing is performed using the servo track SERVO_m read out by the read element when normal write processing on the data track USER DATA_k is performed. The position (RP) is a position at which write processing is performed using the servo track SERVO_m.

At this time, the position (WP) of the write element 122a corresponding to the write processing that uses the servo track SERVO_m, and the position (RP) of the write element 122b corresponding to the read processing that uses the servo track SERVO_m, are misaligned. Both write tests (Filldata) are performed with the misalignment. The processing as described above is performed for each servo track so that write processing on writing to all data tracks on the magnetic disk 11 is performed.

While Filldata as described above is performed, write processing is performed at a read position indicating positions of the read element and the write element during read processing on a data track, and at a write position indicating positions of the read element and the write element during write processing on a data track. As a result of performing this write processing, a track in which the predetermined error (write error) occurs during writing data is registered in the PDM.

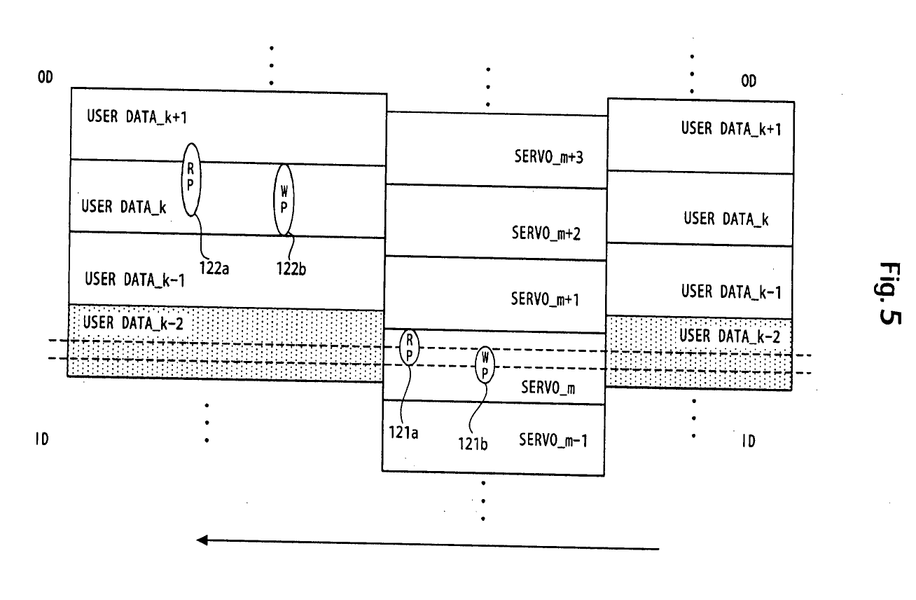

In the case where Filldata is performed, if the write error occurs when write processing is performed at the read position, the data track at which the read element 121a is located is registered in the PDM. FIG. 5 illustrates this state. In addition, in the case where Filldata is performed, if the write error occurs when the read element 121a and the write element 122a are positioned at the read position, the HDD 1 according to this embodiment registers, in the PDM, the data track at which the read element 121a is located. In the case of FIG. 5, the data track USER DATA_k−2 is registered.

As shown in FIG. 5, when a track in which the write error has occurred is registered in the PDM, all data tracks USER DATA_k−2 are registered. Only data tracks USER DATA_k−2 in the vicinity of the servo track SERVO_m used when the write error has occurred, however, may be registered.

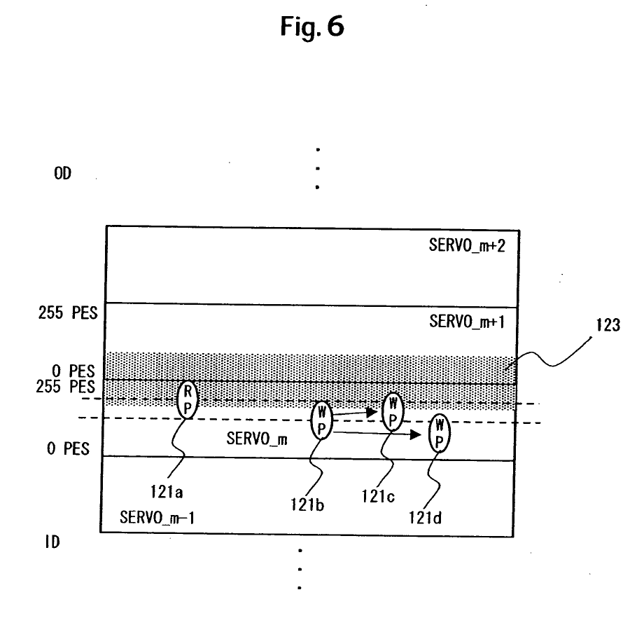

FIG. 6 is an enlarged view illustrating servo tracks used when the write error has occurred during write processing at the read position shown in FIG. 5. In FIG. 6, an error area 123 is formed from the servo track SERVO_m to a servo track SERVO_m+1. In such a case, in Filldata processing corresponding to write processing at the write position (WP), the read element is located at the position of the read element 121b. Accordingly, the write error does not occur. However, in Filldata processing corresponding to write processing at the read position (RP), the read element is located at the position of the read element 121a. Accordingly, the write error occurs.

However, the position of the read element 12 is not constant in the track since the head element 12 vibrates in the track within the allowable range. The position of the read element 121b of the read position for Filldata, the position of a read element 121c, and the position of a read element 121d are misaligned. The positions of the read elements 121c and 121d are at the positions where a user uses the device.

In such a case, for example, in the case of FIG. 6, since the read element 121c cannot read out servo data of the servo track SERVO_m at the position of the write element 121c, the write error occurs. Therefore, both write processing using the servo track SERVO_m and read processing using the servo track SERVO_m are prohibited.

Therefore, the HDD 1 according to this embodiment registers, in the PDM, the data track USER DATA_k−2 and the data track USER DATA_k at which the read element 121a and the write element 122a are positioned, respectively. The registration is performed by using the servo track SERVO_m in which the write error occurs during write processing at the read position (RP) in Filldata processing. As described above, the data track USERDATA_k−2 at which the read element 121a is positioned is registered in the PDM.

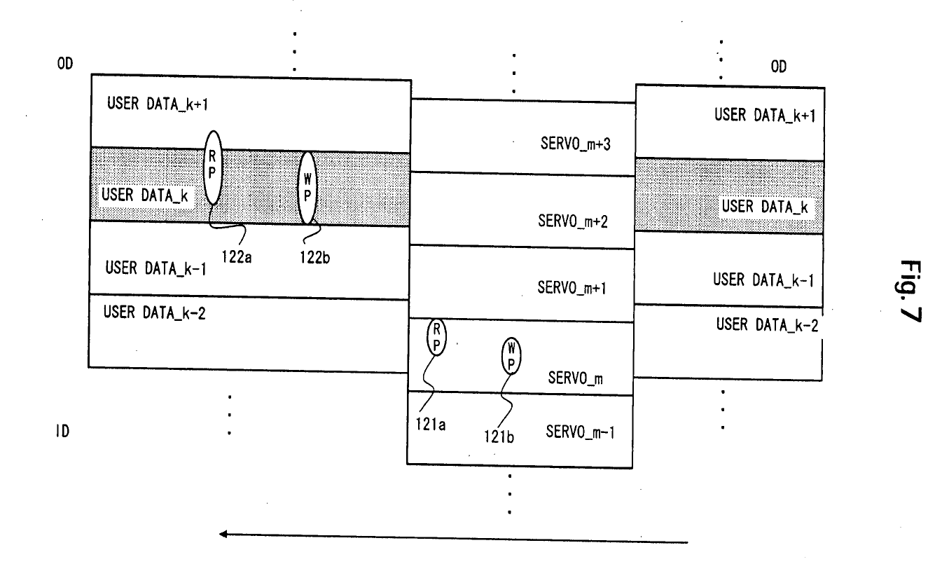

FIG. 7 is a conceptual diagram illustrating PDM registration of a data track at which the write element 122a is located when the write error occurs in write processing at the read position (RP) of the Filldata processing. If the write error occurs during write processing at the read position (RP) of the Filldata processing, the servo track SERVO_m read out by the read element 121a is determined to be defective. When the read element 121a is positioned at the servo track SERVO_m, the data track USER DATA_k at which the write element 122a is located is registered in the PDM.

In this case, the write element 122a at the read position does not always obtain a constant PES value due to vibrations of the head element 12. Therefore, it is desirable to register data tracks adjacent to the data track USER DATA_k in the PDM. In addition, it is also desirable to register, in the PDM, both data tracks adjacent to the data track in which a defect occurs. In FIG. 7, data tracks USER DATA_k−1, USER DATA_k+1 are registered in the PDM.

In another case, write processing at the read position of the Filldata processing is performed. Then, an adjacent data track, which is closer to the position of the write element 122a at which the write error has occurred, may also be registered in the PDM. In FIG. 7, the data track USER DATA k+1 is registered.

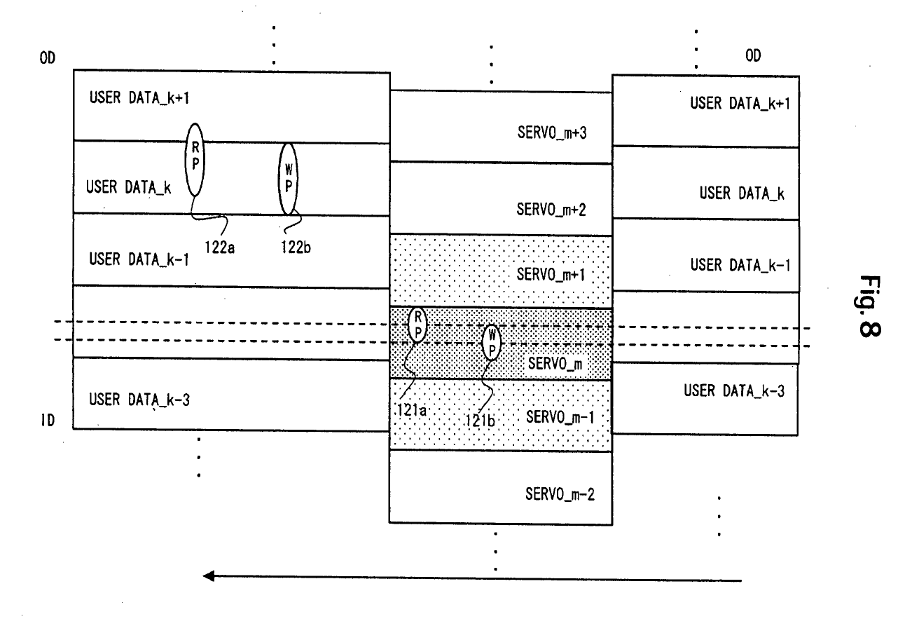

FIG. 8 is a conceptual diagram illustrating PDM registration of a data track in which data write processing is performed using a servo track adjacent to the servo track SERVO_m in which a defect occurs. Moreover, as data tracks in which data write processing is performed using the servo track SERVO_m+1 and the servo track SERVO_m−1, the data track USER DATA_k+1 and the data track USER DATA_k−1 are registered in the PDM.

In still another case, write processing at the read position of the Filldata processing is performed. Then, a data track, in which data write processing is performed using an adjacent servo track that is closer to the position of the read element 121a when the write error has occurred, may also be registered in the PDM. In FIG. 8, the data track USER DATA_k+1 is registered in the PDM.

In the above-mentioned example, the result in FIG. 7 is the same as that in FIG. 8. However, both the data track USER DATA_k+1 and the data track USER DATA_k+2 may use the servo track SERVO_m+1 depending on positions of the read element 121a and the write element 122a of the read position.

Next, description will be made of error registration processing performed when the write error occurs during write processing at the write position of the Filldata processing. If the write error occurs when the read element is positioned at the write position, a servo track used for the positioning at this time is defective. Therefore, a data track corresponding to this servo track is registered in the PDM.

Since there is a high possibility that the write error will occur during use by a user, a data track in which the write element is located at the write position is registered in the PDM. In addition, the HDD 1 according to this embodiment of the present invention, is not required to register in the PDM a data track in which the read element is located at a write position.

If a defect occurs in the servo track at which the read element is located during write processing at the write position in Filldata processing, there is a high possibility that it may not be able to read out data from the data track at which the read element is located. However, even if writing is performed in the track at which this read element is located, it is unclear whether or not the write error will occur. For this reason, the HDD 1 is not required to register the data track in the PDM.

When read processing of this data track is performed, it is considered that a read error occurs since servo data of this track is defective. However, since it is possible to perform a read retry after off-track is generated, there may be a possibility of reading data in this track. Judging from the above, in order to reduce the possibility that the PDM may overflow because of the limited size of the PDM, it is not required to register in the PDM the data track at which the read element is located during the write processing at the write position of the Filldata processing.

As described above, the data storage device includes the head in which the positions of the read element and the write element differ from each other in the radial direction of the disk. The data storage device performs positioning of the head by reading out servo data written on the disk using the read element. When data write processing is performed by the write element with the read element being positioned at a target position at which normal data reading is performed, if the write error occurs during the data write processing, areas in a data track in which normal data writing is performed using a servo track including the target position are registered as an error area. As a result, it becomes possible to detect a defective servo track, which could not be detected by the conventional methods, and thereby it is possible to greatly reduce the number of times a malfunction occurs in the data storage device. This makes it possible to reduce the possibility of manufacturing a data storage device in which a malfunction occurs.

Incidentally, the present invention is not limited to the embodiments described above, and as a matter of course, embodiments of the present invention can be changed in various ways within the range that does not deviate from the gist of the present invention. In addition, although the defect handling method in Filldata was described in the above-mentioned embodiments, the defect handling method is not limited to this. With respect to the above PDM registration of the defective data track, all data sectors included in the track may be registered. However, it may also be configured such that some of data sectors included in an area in which the defective servo track is located are registered. Moreover, although the HDD is used in the embodiments described above, the present invention is not limited to the HDD.

What is claimed is:

1. A defective area management method for a data storage device, said data storage device comprising a head in which positions of read and write elements differ from each other in the radial direction of a disk, said defective area management method performing positioning of the head by reading out servo data written on the disk using the read element, said method comprising the steps of:
performing data write processing by the write element with the read element being positioned at a target position at which normal data reading is performed; and
registering areas in a data track in which normal data writing is performed using a servo track including the target position, as an error area, if a predetermined error occurs in the data write processing.

2. The method according to claim 1, wherein:
in addition to the areas in the data track in which normal data writing is performed using the servo track including the target position, areas in a data track adjacent to the data track are registered as an error area.

3. The method according to claim 2, wherein:
the adjacent data track is closer to the write element used for the data write processing.

4. The method according to claim 1, wherein:
in addition to the areas in the data track in which normal data writing is performed using the servo track including the target position, areas in each of adjacent data tracks on both sides of the data track registered as an error area.

5. The method according to claim 1, wherein:
all data areas in each data track in which normal data writing is performed are registered as an error area.

6. The method according to claim 1, wherein:
error registration of an area included in each data track corresponding to the target position is further performed.

7. The method according to claim 1, wherein:
in addition to the areas in the data track in which normal data writing is performed using the servo track including the target position, areas in a data track in which normal data writing is performed using a servo track adjacent to the servo track are registered as an error area.

8. The method according to claim 7, wherein:
the adjacent servo track is closer to the target position.

9. The method according to claim 1, wherein:
in addition to the areas in the data track in which normal data writing is performed using the servo track including the target position, areas in each data track in which normal data writing is performed using each of adjacent servo tracks on both sides of the servo track are registered as a defective.

10. A data storage device comprising:
a head in which positions of read and write elements differ from each other in the radial direction of a disk;
a controller for performing positioning control of the head on the basis of servo data read out from the disk by the read element, and thereby for performing data write processing by the write element with the read element being positioned at a target position at which normal data reading is performed; and
a memory for storing as an error area areas in a data track in which normal data writing is performed using a servo track including the target position if a predetermined error occurs in the data write processing.

11. The data storage device according to claim 10, wherein:
the memory stores, as an error area, not only the areas in the data track in which normal data writing is performed using the servo track including the target position, but also areas in a data track adjacent to the data track.

12. The data storage device according to claim 11, wherein:
the adjacent data track is closer to the write element used for the data write processing.

13. The data storage device according to claim 10, wherein:
the memory stores, as an error area, not only the areas in the data track in which normal data writing is performed using the servo track including the target position, but also areas in each of adjacent data tracks on both sides of the data track.

14. The data storage device according to claim 10, wherein:
the memory stores, as an error area, not only the areas in the data track in which normal data writing is performed using the servo track including the target position, but also areas in a data track in which normal data writing is performed using a servo track adjacent to the servo track.

15. The data storage device according to claim 14, wherein:
the adjacent servo track is closer to the target position.

16. The data storage device according to claim 10, wherein:
the memory stores, as an error area, not only the areas in the data track in which normal data writing is performed using the servo track including the target position, but also areas in each data track in which normal data writing is performed using each of adjacent servo tracks on both sides of the servo track.

17. A data storage device comprising:
a head in which positions of read and write elements differ from each other in the radial direction of a disk;
a controller for performing positioning control of the head on the basis of servo data read out from the disk by the read element, and thereby for performing data write processing by the write element with the read element being positioned at a target position at which normal data writing is performed; and
a memory for storing, as an error area, areas in a data track in which normal data reading is performed using a servo track including the target position if a predetermined error occurs in the data write processing.

18. The data storage device according to claim 17, wherein:
the memory stores, as an error area, not only the areas in the data track in which normal data writing is performed using the servo track including the target position, but also areas in a data track adjacent to the data track.

19. The data storage device according to claim 17, wherein:
the memory stores, as an error area, not only the areas included in the data track in which normal data writing is performed using the servo track including the target position, but also areas in a data track in which normal data writing is performed using a servo track adjacent to the servo track.
